(19) United States
(12) Patent Application Publication
(10) Pub. No.: US 2006/0190364 A1
(43) Pub. Date: Aug. 24, 2006

(54) Method and system for improved bill of material creation and maintenance

(75) Inventors: Vasile E. Bizovi, West Hurley, NY (US); Ghassan Chidiac, Wappingers Falls, NY (US); Robert E. Cremins, Poughkeepsie, NY (US)

Correspondence Address: FLEIT, KAIN, GIBBONS, GUTMAN,;BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 11/052,696

(22) Filed: Feb. 7, 2005

(51) Int. Cl. G06F 17/50

(52) U.S. Cl. 705/29

(57) ABSTRACT

A central information processing system and method create and maintain a bill of materials (BOM) for design and manufacture of a product linking by receiving a BOM, assembled to a predefined point of completion adequate for processing by a reviewing party, automatically communicating feedback to the reviewing party indicating the BOM is ready for processing and iteratively: processing the BOM by the reviewing party and automatically communicating feedback to the originating party for editing, then automatically notifying the reviewing party that the BOM is ready for processing. While processing the BOM, the method determines a level of collaboration review for each component part of the BOM based upon the chronological stage of the design and whether the component part has a pre-existing manufacturing part number. Further processing is dependant upon the level of collaboration.

### BACKGROUND OF THE INVENTION

1. Field of the Invention

This invention generally relates to the field of computer based commodity tracking, and more particularly relates to a system and method to facilitate, communicate, and track commodity content reviews, recommendation exchange, new part initiation, and new part approvals.

2. Description of Related Art

A typical OEM (Original Equipment Manufacturer) product is comprised of numerous parts or components which the company selects in order to achieve their end product design objectives. Within the OEM company, the task of meeting the end product objectives is usually given to development personnel. These same development personnel ultimately have the responsibility for selecting the parts to meet their end product objectives. Development personnel normally have a technical or engineering background and are focused on meeting the performance requirements and specifications of their end product. Dramatically reduced resources and compressed development schedules, which are a characteristic of today's marketplace, also provide a challenge to development personnel in achieving their goal. As a result, development often does not have the expertise or time to pay adequate attention to other factors involved in selecting parts, which could have a dramatic impact on the success of the end product.

Obviously, the ability of the end product to perform as specified is a function of the ability of the parts to perform as expected. In addition to performance, the cost to produce the product is largely a function of the cost of the parts in the product Bill of Materials (BOM) and the costs associated with part acquisition, supply chain management, and assembly. Further, the quality and reliability of the parts will dictate the quality and reliability of the end product, which will impact the warranty costs and customer satisfaction. All of these factors ultimately impact the profit margin of the product and its success in the marketplace.

The vast majority of OEMs do not manufacture most of the parts or components used in their end products. Instead, the parts are procured from various suppliers who specialize in the development, manufacturing and sale of their individual component types. Competition among these component suppliers is fierce as they each attempt to advertise their offerings and persuade OEM development personnel to select their components for new product designs. For many component types, the initial components selected will dictate or perhaps limit the available suppliers. Obviously there are significant differences across both the supplier base and the component technologies that they offer, which can impact the various end product success factors already discussed. The barrage of supplier information together with the pressures and limitations already mentioned increase the potential for development to select non-optimized components and/or suppliers.

Given the importance of the parts within a BOM and the fact that the majority are procured externally, most OEM companies must have procurement and/or supply chain specialists who are assigned to manage all aspects of procured parts. These personnel manage the component supplier relationships, costs, contracts, qualification, quality, supply chain logistics and problem solving. To be successful, they must have expertise on their component commodity which covers the specific commodity marketplace, industry trends, technology roadmaps, and the worldwide supplier base availability. Equally important is an understanding of the needs of their development teams and their company's end product objectives. Obviously these personnel have a strong interest in the initial component and/or supplier selection, which they will ultimately have to manage. More importantly, their knowledge and expertise can bring significant value to the selection process and ultimately the end resultant OEM product.

The key to maximizing the value of procurement expertise in the part selection process is to create a timely, easy and effective communication channel between development and procurement personnel. This is simple in theory but quite difficult in practice. There are several large complexity factors involved mainly dealing with process, personnel and overall simplicity, which make this objective difficult to achieve.

The realities of the typical design environment must be accounted for in this process. Development of a product is often iterative with multiple, unstructured revisions sometimes occurring concurrently. This “sandbox” environment does not lend it self to structured information sharing. To be effective, procurement must provide their input early enough in the design process when there is time and flexibility to make meaningful changes. In practice, development will pass a BOM “over the wall” to procurement either when they want to or are required to by a corporate guideline. Procurement must then review all of the parts and associated detail. Since a typical BOM consists of multiple part types or commodities, there are multiple procurement experts who must review the same BOM. The “value added” input of all these various procurement experts must then somehow be pulled together in a meaningful format and provided back to the Designer in a timely and meaningful fashion for review, implementation and/or follow-on questions and answers. Depending upon the complexity of the BOM and the commodity content, this follow-on question and answer exchange may entail an extensive, threaded chain of back and forth dialog between the designer and multiple procurement commodity experts simultaneously.

Added to the above complexity is the reality of human personalities. Development personnel are naturally very involved and perhaps somewhat protective of their work. They may not recognize the value of procurement in their part selection process and hesitate to share their ‘work in process’ outside their immediate team. Likewise, procurement may not have an adequate working level understanding of development challenges and objectives. Development and procurement personnel typically have different measurements, priorities, and management, which often result in cultural differences which can create operational ‘walls’ between the two organizations. These differences can make communication difficult.

Lastly, the communication process must be simple, efficient, and easy to access otherwise neither side will be willing or able to maximize the benefits. The challenges of process and personnel make simplicity difficult to achieve. This communication exchange must occur completely in sync with the development process and not be considered as a hindrance. Also, given the national or international scope of most major OEMs, development and procurement personnel may be geographically separated and perhaps never able to meet face to face. Any solution must take these practical aspects into account to be successful.

Therefore a need exists to overcome the problems with the prior art as discussed above, and particularly for a method to facilitate, communicate, and track commodity content reviews, recommendation exchange, new part initiation, and new part approvals.

### SUMMARY OF THE INVENTION

According to a preferred embodiment of the present invention, a computing system and method create and maintain a bill of materials (BOM) for design and manufacture of a product by linking, over a network, a plurality of client information processing systems to at least one central processing system; receiving a bill of materials assembled to a predefined point of completion adequate for processing by a reviewing party from an originating party's client information processing system; and communicating feedback to the reviewing party's client information processing system, automatically, in response to receiving the bill of materials, indicating the bill of materials is ready for processing. Then, a reviewing party processes the BOM and automatically communicates feedback to the originating party indicating the BOM has been processed; the originating party edits the BOM and again automatically notifies the reviewing party that the BOM is ready for processing.

The BOM is assembled by the originating party's client information system by validating details of all component parts within the bill of materials, specifying a chronological stage of design, sorting each component part into predefined commodity categories and entering product details and requirements. The chronological stage of the design is one of: concept, logic design, physical design, prototype, and production.

The reviewing party's client information system processes the BOM by determining a level of collaboration review for each component part of the BOM based upon the chronological stage of the design and whether the component part has a pre-existing manufacturing part number. The levels of collaboration review are “no review,” “recommendation,” and “new part number request. When the level of collaboration review is “no review,” a response indicating no review is necessary is automatically incorporated into the feedback.

When the level of collaboration review is “recommendation,” the reviewing party can approve the component part and a response indicating the approval of the component part is automatically incorporated into the feedback. If the reviewing party disapproves the component part, the reviewing party suggests an alternate component part and a response indicating the disapproval of the component part is automatically incorporated into the feedback.

When the level of collaboration review is “new part number request,” the reviewing party has the option to defer approval of the component part until additional information is received, determine not to support the new part number, or support the new part number. If the reviewing party defers, additional information is requested and a response indicating the at least one of the deference of the component part and the request for additional information is automatically incorporated into the feedback. If the reviewing party determines not to support the new part number, a response indicating at least one of the determination not to support the component part and comments indicating reasons for not supporting the new part number is automatically incorporated into the feedback. If the reviewing party determines to support the new part number, the component part is assigned a new part number, the new part number and any relevant information pertaining to the usage of the component part is entered into the BOM, and a response indicating the new part number for the component part is incorporated into the feedback automatically. Additionally, an engineering change request is created automatically using relevant data about the new part number.

The originating party's client information system edits the BOM by selecting a component part of the BOM requiring action, determining whether the component part needs to be replaced, and updating the bill of materials to reflect the replaced part. Additionally, the originating party may determine a recommended supplier needs approval and approve or disapprove the recommended supplier. If the recommended supplier is disapproved, a response indicating the supplier disapproval and, optionally, reasons for not approving the recommended supplier is incorporated into the feedback automatically. If the recommended supplier is approved, a response indicating the supplier approval is incorporated into the feedback automatically.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a commodity review solution (CRS) system in accordance with an exemplary embodiment of the present invention.

FIG. 2 is a more detailed block diagram illustrating the computer system of FIG. 1, containing a commodity review solution tool, in accordance with an exemplary embodiment of the present invention.

FIG. 3 is a more detailed block diagram illustrating a commodity review solution server of the system of FIG. 1, in accordance with an exemplary embodiment of the present invention.

FIGS. 4, 5, and 6 are operational flow diagrams illustrating exemplary operational sequences for the system of FIG. 1, according to a preferred embodiment of the present invention.

FIG. 7 is a table depicting review types based on bill of material (BOM) state and availability of part numbers for the system of FIG. 1, in accordance with an exemplary embodiment of the present invention.

FIG. 8 is an operational flow diagram illustrating an exemplary operational sequence for the system of FIG. 1, according to a preferred embodiment of the present invention.

### DESCRIPTION OF THE PREFERRED EMBODIMENTS

Terminology Overview

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an,” as used herein, are defined as “one or more than one.” The term “plurality,” as used herein, is defined as “two or more than two.” The term “another,” as used herein, is defined as “at least a second or more.” The terms “including” and/or “having,” as used herein, are defined as “comprising” (i.e., open language). The term “coupled,” as used herein, is defined as “connected, although not necessarily directly, and not necessarily mechanically.” The terms “program,” “software application,” and the like as used herein, are defined as “a sequence of instructions designed for execution on a computer system.” A program, computer program, or software application typically includes a subroutine, a function, a procedure, an object method, an object implementation, an executable application, an applet, a servlet, a source code, an object code, a shared library/dynamic load library and/or other sequence of instructions designed for execution on a computer system. The terms “hardware engineer,” “development engineer,” “hardware development engineer,” and “designer” are used interchangeably.

Overview

This invention relates to a systematic methodology to manage various types of communication between development and supply chain or procurement personnel with the ultimate objective of optimizing the end product for cost, supply flexibility/availability, quality, reliability, and performance. This methodology involves the mating or matching of the appropriate level of collaboration on a particular part based upon the chronological stage of the particular design or Bill of Materials (BOM). The amount of resources to apply to the collaboration process is a function of the level of flexibility that exists for a part to be changed in a particular design. The greatest potential for change is during the early stages of design; therefore, the maximal level of collaborative effort should be applied during the early stages. In the later stages of a design, most of the BOM content is fixed so the level of collaboration required is significantly less.

The present invention, according to one embodiment, overcomes problems with the prior art by providing a framework for development and procurement personnel to truly and easily collaborate on selection of parts at any point during the design process. A systematic methodology facilitates the various types of communication that must occur between development and procurement to enable collaboration on the part selection process. These types of communication can be categorized into four main areas:
Communication of a BOM, with all required part detail and end product requirements from development to procurement.
Communication of part recommendations, existing part number approval (including identification and initiation of a new part number) from procurement to development.
Two-way communication between procurement and development to facilitate question and answer exchange on requirement and recommendation details.
Capability for development, procurement, or other authorized personnel to have “on demand” access to the latest communication status at either a BOM or part level.
   Computer System

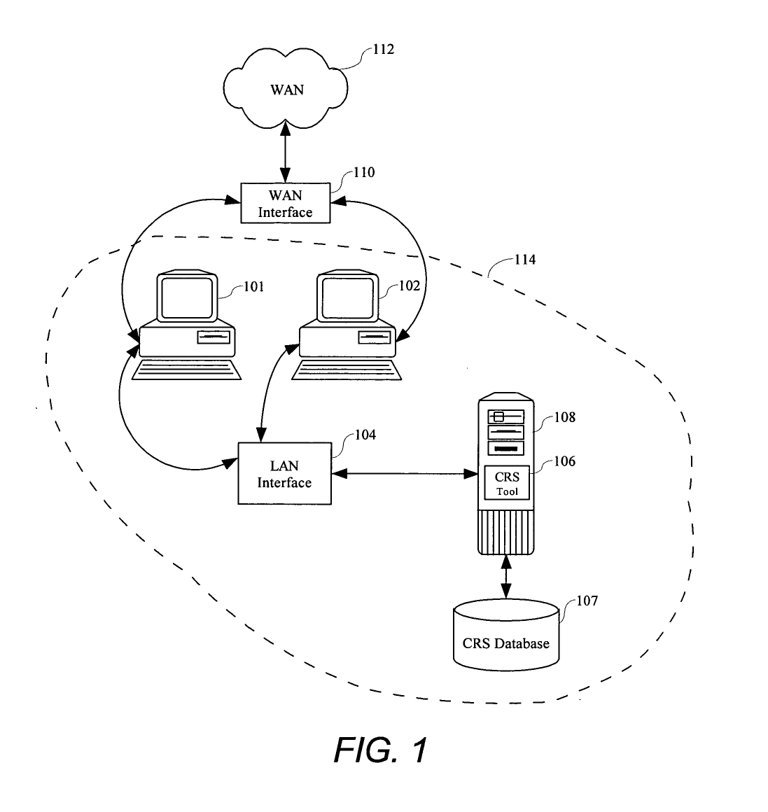

FIG. 1 illustrates an exemplary commodity review solution (CRS) system 100, or central information processing system, according to an embodiment of the present invention. Each CRS system 100 includes, inter alia, one or more client information processing systems 101, 102, communicating via a local area network interface 104, and a commodity review solution tool 106 and database 107. The local area network interface 104 may be a wired communication link or a wireless communication link. Additionally, each client information processing system 101, 102 may also be communicatively coupled with a wide area network 112 such as the Internet, through a wired, wireless, or combination of wired and wireless communication links via a wide area network communication link 110. The commodity review solution tool 106 and database 107, in the exemplary embodiment, are located on a remote server 108 of the local area network 114. The server 108 may alternately be located remotely on the wide area network 112. Additionally, the commodity review solution tool 106 and database 107 may reside locally on one or more of the computer systems 101, 102.

As indicated in FIG. 1, in an exemplary embodiment, the CRS tool 106 uses XML (eXtensible Markup Language) and MQSeries middleware to receive all the details of the BOM. This is an industry standard interface, which allows CRS 106 to easily communicate with other applications.

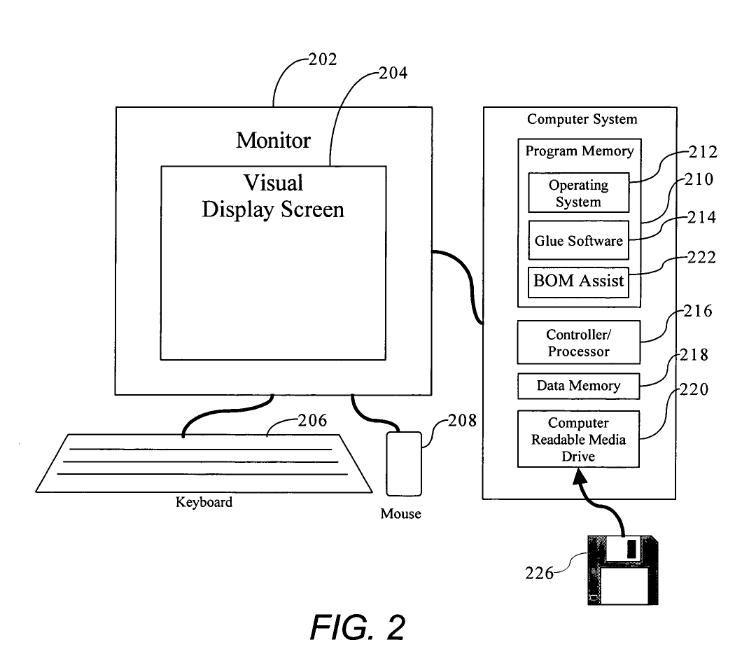

Referring to FIG. 2, the client information processing system 101, 102, according to the present example, includes a controller/processor 216 which processes instructions, performs calculations, and manages the flow of information through the client information processing system 101, 102. Additionally, the controller/processor 216 is communicatively coupled with program memory 210. Included within program memory 210 are a BOM Assist application 222 (which will be discussed later in greater detail), operating system platform 212, and resource management or glue software 214. The operating system platform 212 manages resources, such as the data stored in data memory 218, the scheduling of tasks, and processes the operation of BOM Assist application 222 in the program memory 210. The operating system platform 212 also manages a graphical display interface (not shown), a user input interface (not shown) that receives inputs from the keyboard 206 and the mouse 208, and communication network interfaces (not shown) for communicating with the network link 104. Additionally, the operating system platform 212 also manages many other basic tasks of the client information processing system 101, 102 in a manner well known to those of ordinary skill in the art.

Glue software 214 may include drivers, stacks, and low level application programming interfaces (API's) and provides basic functional components for use by the operating system platform 212 and by compatible applications that run on the operating system platform 212 for managing communications with resources and processes in the client information processing system 101, 102.

Software and Computer Program Medium

In this document, the terms “computer program medium,” “computer-usable medium,” “machine-readable medium” and “computer-readable medium” are used to generally refer to media such as non-volatile program memory 210, data memory 218, removable storage drive 220, a hard disk installed in hard disk drive (not shown), and signals. These computer program products are means for providing software to the client information processing system 101, 102. The computer-readable medium allows the client information processing system 101, 102 to read data, instructions, messages or message packets, and other computer-readable information from the computer-readable medium. The computer-readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer-readable medium may comprise computer-readable information in a transitory state medium such as a network link and/or a network interface, including a wired network or a wireless network, that allow a computer to read such computer-readable information.

Various software embodiments are described in terms of this exemplary system. After reading this description, it will become apparent to a person of ordinary skill in the relevant art(s) how to implement the invention using other computer systems and/or computer architectures.

Commodity Review Solution Server

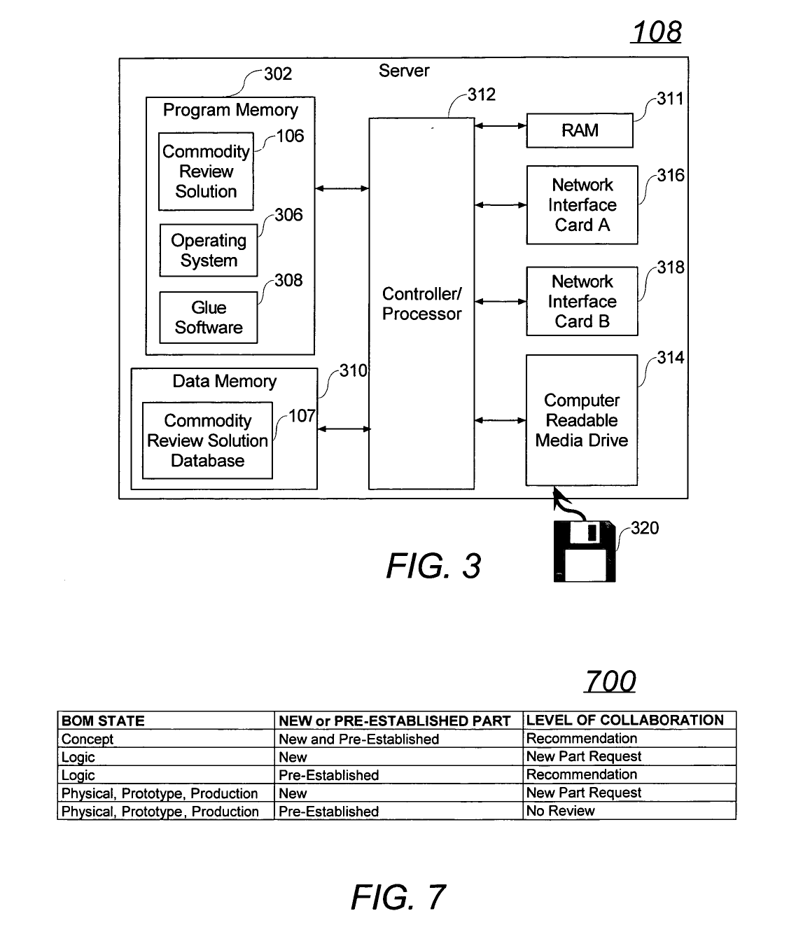

A more detailed block diagram of a commodity review solution server 108 according to a preferred embodiment of the present invention is shown in FIG. 3. The server 108 includes one or more processors 312 which process instructions, perform calculations, and manage the flow of information through the server 108. The server 108 also includes a program memory 302, a data memory 310, and random access memory (RAM) 311. Additionally, the processor 312 is communicatively coupled with a computer readable media drive 314, network interface cards (NIC) 316 and 318, and the program memory 302. The network interface cards 316 and 318 may be wired or wireless interfaces.

Included within the program memory 302 are a commodity review solution tool 106, operating system platform 306, and resource management or glue software 308. The operating system platform 306 manages resources, such as the commodity review solution database 107 and other information stored in data memory 310 and RAM 311, the scheduling of tasks, and processes the operation of the commodity review solution tool 106 in the program memory 302. Additionally, the operating system platform 306 also manages many other basic tasks of the server 108 in a well-known manner.

Glue software 308 may include drivers, stacks, and low-level application programming interfaces (API's); it provides basic functional components for use by the operating system platform 306 and by compatible applications that run on the operating system platform 306 for managing communications with resources and processes in the server 108.

Commodity Review Solution

An embodiment of the present invention consists of a systematic methodology to facilitate the various types of communication that occurs between development and procurement divisions within an organization when designing and manufacturing a product. These types of communications are categorized into four main areas:
Communication of a BOM, with all required part detail and end product requirements from development to procurement.
Communication of part recommendations, existing part number approval (including identification and initiation of a new part number) from procurement to development.
Two-way communication between procurement and development to facilitate question and answer exchange on requirement and recommendation details.
Capability for development, procurement or other authorized personnel to have “on demand” access to the latest communication status at either a BOM or part level.

In order to achieve maximum efficiency, an embodiment of the present invention must seamlessly handle each type of communication. Additionally, to create a systematic, repeatable methodology which can also be embodied in a computerized solution, several variables must be properly defined. These are the chronological stage of a design, whether or not a part is new or pre-established, and the level of collaborative communication. The chronological stage of a design is referred to as the Bill of Material State or the “BOM State,” which are: Concept, Logical Design, Physical Design, Prototype, and Production.

Within a given BOM, there are parts that are considered new and others that are re-used from previous designs and already established in the OEM's part database. Whether a particular part is new or already established is another indicator of the flexibility for change and therefore must be taken into account when determining the appropriate level of collaboration. The levels of collaborative communication are:
Manual exchange of recommendations for initial part selection (termed RECOMMENDATION)
Manual exchange of required detail for a new part initiation (termed NEW PART REQUEST)
Automatic communication of part status based on pre-defined criteria and part level data contained within the OEM's part database (termed NO REVIEW)

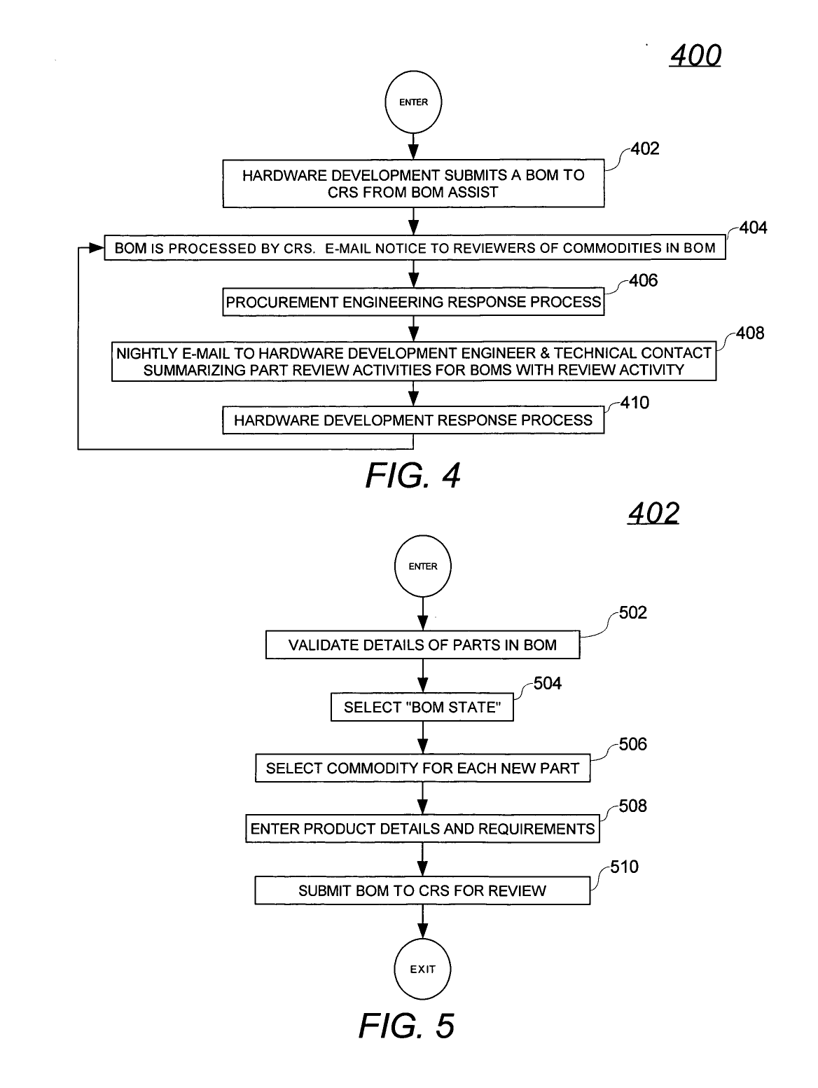

FIG. 4 is an exemplary operational flow diagram providing an overview of the method performed by the entire CRS system 100 operation. The method begins, at step 402, when an originating party, typically a hardware development engineer, uses the BOM assist application 222 to create and submit a BOM to the CRS tool 106. The BOM submission indicates that the hardware engineer has completed the BOM to a point where there is adequate information for a reviewing party, typically a procurement engineer, to begin examination of the chosen component part. The BOM is stored in the CRS database 107, at step 404, and an e-mail notification is sent to the appropriate commodity reviewer in procurement engineering, as listed in the BOM, to advise that a BOM is ready for review. At step 406, the procurement engineer processes a response, and the CRS tool 106, at step 408, generates a nightly e-mail to the corresponding hardware development engineer and technical contact that summarizes all part review activities for BOMs with review activity. Then the hardware development engineer processes a response to the updated BOM, at step 410, and this process continues throughout the development and production cycle of the product. Each type of communication will now be discussed in detail.

Communication of a BOM with All Required Part Detail and End Product Requirements from Development to Procurement

The communication of a BOM, with all required part detail and end product requirements, from development to procurement, is accomplished when a development submits a BOM to the Commodity Review Solution (CRS). This communication stage includes both the initial submission and subsequent revision management. The required part details are:
Commodity or part type
Description including supplier name and supplier part number (P/N) or OEM P/N
Quantity used per BOM
Special specification or performance requirements (if any)
End product detail and requirements are:
Product name
Schedule and life cycle requirements
Development contact information

FIG. 5 depicts step 402 of the overall process shown in FIG. 4, when the hardware engineer assembles and submits an initial BOM. The hardware development engineer, using the BOM Assist application 222, validates the details of the parts contained in the BOM, at step 502. Next, the development engineer selects the “BOM state”, i.e. phase of the design phase (concept, logic design, physical design, prototype, or production), at step 504.

The “BOM state” is the current state of the BOM in the development process. These are divided into pre-defined options representing the typical chronological stages of an OEM development process. The BOM state information is necessary in order to communicate the level of change flexibility that exists in a design. For example, a ‘concept’ design, still in its infancy, will typically have greater flexibility and be able to accept more part change recommendations than a design which is already at the ‘prototype’ stage requiring only final approval and/or administrative part number release support for parts already selected. The CRS tool 106 can manage the communications required for early or late design situations as well as those situations in between. Then, at step 506, each part within the BOM is sorted into predefined commodity categories for rapid review by the specific procurement expert or experts for each commodity. This step is essential to the initial communication between- development and procurement. Next, at step 508, the product details and requirements are entered. When the hardware development engineer has completed the initial design of the product to a predetermined point containing adequate information for procurement engineering to begin review, the BOM, with the associated details, is submitted to the Commodity Review Solution for review, at step 510.

Referring back to FIG. 4, at step 404, the Commodity Review Solution (CRS) tool 106 stores the BOM, with its part details, product details, and product requirements into the CRS database 107. Next, the CRS tool 106 sorts the parts in the BOM by commodity. Then, the CRS tool 106 determines what type of review is required for each part based on the BOM state. If a part requires a review, the CRS tool 106 sends an e-mail to the commodity procurement expert(s) responsible for that commodity, notifying them that CRS has received parts requiring their review. Additionally, the hardware development engineer who submitted the BOM is sent an e-mail notifying that the BOM has been stored into the CRS database 107. Depending upon the BOM state, this same e-mail may also contain automated answers from procurement for certain parts, based on the pre-defined criteria.

Communication of Part Recommendations, Existing Part Number Approval (Including Identification and Initiation of a New Part Number) from Procurement to Development

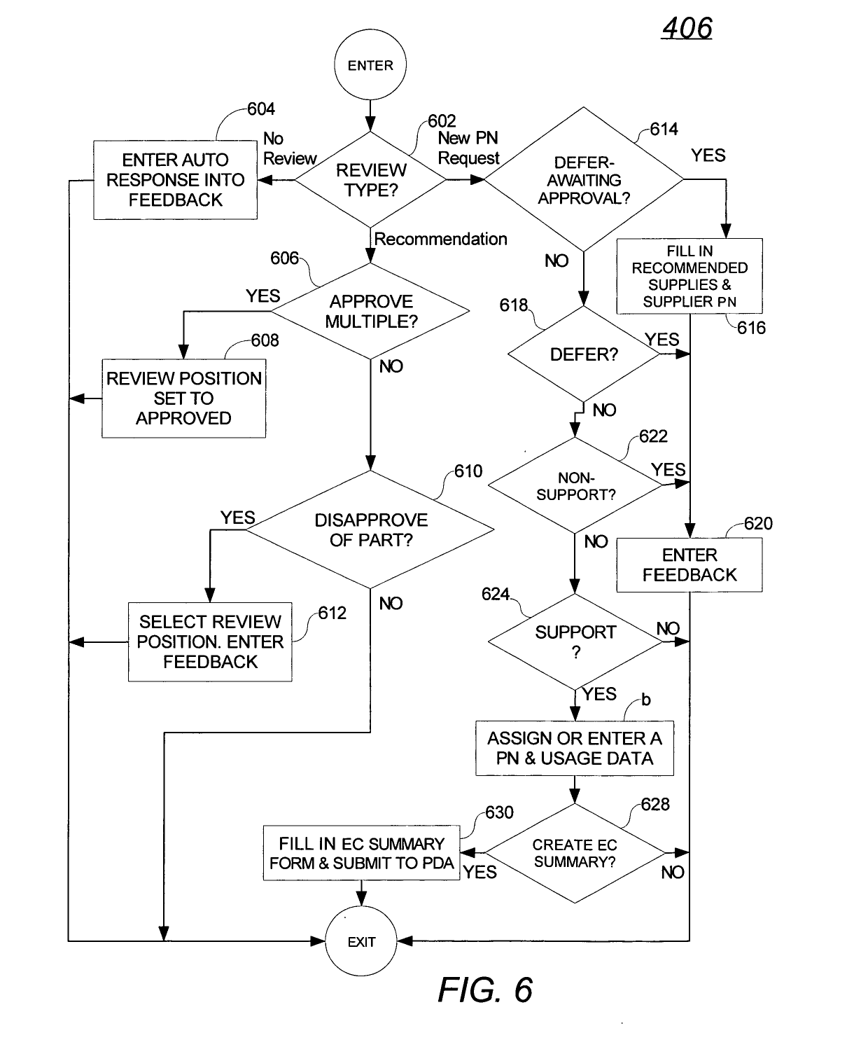

In this type of communication, details must again include part description, suppliers and supplier part number or OEM part number but may also include attachments or links to provide further part detail which the designer may need to assess procurement's input. Key to this communication is the reintegration of input on each part or commodity within the BOM from a number of procurement experts into a single organized and usable format for development review. Commodity procurement personnel have a process for reviewing parts that is both facilitated by and tracked within the CRS tool 106, as depicted in FIG. 6. The process begins, at step 602, when the CRS tool 106 determines the review type for each part. The proper level of collaboration for a specific part on a specific BOM is defined in the table of FIG. 7. The collaboration level is based upon the chronological stage of the design, and whether or not the part is new or pre-established, in order to maximize the return on investment of resources. For example, when processing a BOM in the “concept” state, all parts are set up requesting a review for “recommendations.” For a BOM in the “logical design” state, parts with pre-existing part numbers are set up for a “recommendation” review while new parts are set up as “new part requests.” For the later three BOM states, only new parts are set up for “new part request” reviews while parts with pre-existing part numbers are determined “no review” and automatically answered, at step 604, via a predefined part number level criterion.

For reviews requiring a “recommendation,” the Commodity procurement expert can approve all the parts (no recommendations), at step 606, in which case the review position is set to “approved,” at step 608. Alternatively, if the procurement expert disapproves of a part selection, at step 610, he/she may provide a recommendation for an alternative part and communicate details via text and/or attachments, at step 612. Attachments may be a conventional type and/or a “hot linked” URL.

For “new part request” reviews, the Commodity procurement expert has a number of options. First, the procurement expert may choose to defer approval of a new part number pending receipt of additional information. Within this category is the potential situation in which procurement may desire different or additional suppliers for the requested part type and “defer” the new part request pending receipt of designer concurrence. In that situation, the procurement engineer, at step 614, defers approval of the new part number and recommends a substitute supplier part number, at step 616. Text and/or attachments are used to communicate the recommendation back to the designer, at step 620. Otherwise, the procurement engineer, at step 618, may simply choose to defer approval, at step 618, pending receipt of additional information. Again, this information is communicated back to the designer, at step 620, via text and/or e-mail attachments. If the procurement engineer chooses not to defer, at steps 614 and 618, he/she may choose, at step 622, not to support the request. As with a recommendation, reason details can be communicated to the designer via text and/or attachments, at step 620. As a final option, at step 624, the part number request can be supported, in which case, the procurement engineer, assigns or enters a new part number and any other relevant information pertaining to the usage of the new part, (such as a code to identify how the part can be used and re-used in the future based on its complexity and projected reliability) and communicates the new part number to the designer at step 626. The procurement engineer may then choose to launch the new part number engineering change (EC) release process, at step 628, by entering the information into an EC summary form and submits it to the appropriate channels. Key data from the collaboration is automatically imported on to the EC form, thereby reducing cycle time and an opportunity for human error.

Referring again to FIG. 4, all activities on the parts in a BOM that occur each day are re-integrated and stored at the BOM level within the CRS database 107 as well as summarized in an e-mail, which is sent nightly to both the designer and an optional predefined technical contact for their review, at step 408. In an exemplary embodiment, the e-mail also contains a hot link into the CRS tool 106 which enables the development engineer to rapidly access a specific BOM via a different set of views, pre-defined for development use. The designer may also access these same views at any time by using the CRS tool 106 directly to review the status of one or more BOMs.

Two-Way Communication Between Procurement and Development to Facilitate Question and Answer Exchange on Requirement and Recommendation Details.

For any part on a BOM, there may be a need for several communications back and forth between the designer and the commodity procurement expert to optimize the final part. The most likely scenarios are:
Clarification on specific development application needs or limitations.
Clarification of details associated with a procurement recommendation.
Development approval of a procurement recommended part and/or supplier(s) selection prior to new part initiation.

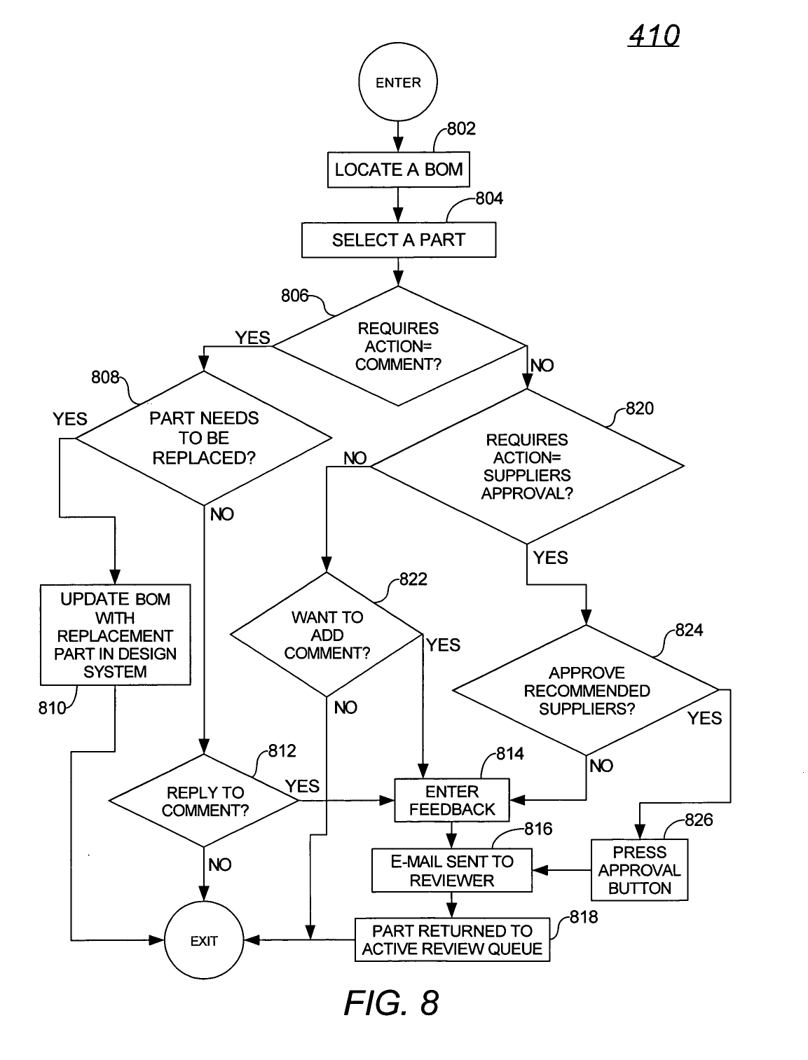

When the designer receives the nightly e-mail, parts on the BOM that require the designer action to review detail or follow-up on are denoted as such in both the e-mail and the designer view within the CRS tool 106. The designer can see which parts have been responded to by procurement, review the detailed procurement responses including attachments, and respond to procurement input, including approval or disapproval of supplier changes requested by procurement for a “new part request.” This process is depicted in FIG. 8, where the designer locates the desired BOM, at step 802, and selects a part for review, at step 804. If the part requires action in response to a comment from procurement, at step 806, the designer determines if the part needs to be replaced, at step 808, and updates the BOM with the replacement part in the design system (generally a schematic capture software package), at step 810. If the designer decides, at step 808, that the part does not need to be or cannot be replaced, he may choose, at step 812, to reply to the comment from procurement by entering feedback, at step 814, which is then e-mailed to the procurement reviewer, at step 816, and returned to the active review queue, at step 818. If, at step 810, there is no action required in response to a procurement comment, the designer checks to see if action is required to approve a recommended supplier or supplier part number, at step 820. If no action is required, the designer may choose, at step 822, to add a comment by entering feedback, at step 814, which is then e-mailed to the procurement reviewer, at step 816, and returned to the active review queue, at step 818. If, at step 820, action is required to approve a recommended supplier or supplier part number, the designer may choose, at step 824, to approve the recommended supplier, which is done simply by pressing the approval button, at step 826, e-mailed to the procurement reviewer, at step 816, and returned to the active review queue, at step 818. If the designer chooses not to approve the recommended supplier, at step 820, he/she enters feedback expressing reasons for not approving the recommended part and/or supplier, at step 814, which is then, once again, e-mailed to the procurement reviewer, at step 816, and returned to the active review queue, at step 818.

Key to this exchange is the rapid communication and notification on either side (development and procurement) that new information is available to be reviewed and acted upon. As depicted in FIG. 8, the CRS tool 106 sends an e-mail with a “hot link” into the CRS tool 106 to either party if there is a new piece of information requiring their review. In addition, for each item within a BOM, the CRS tool 106 maintains a time stamped record of the ongoing thread of dialog between both parties including the actual detail communicated. This information is retained and added to as the BOM evolves and its state matures throughout the OEM development process.

Capability for Development, Procurement or Other Authorized Personnel to have “On Demand” Access to the Latest Communication Status at Either a BOM or a Part Level

The CRS tool 106 retains both an up-to-the-minute as well as a historical account of all relevant communications and resultant approvals or disapproval on all parts within the BOM, which have occurred up to that point. Separate pre-defined “read only” views are available for personnel who may wish to either understand status of a specific BOM, view detail on a specific part within a BOM or view responsiveness of either procurement or development personnel.

The commodity review solution system 100 of embodiments of the present invention provides great advantages to a user. For example, a key element of the present invention is the ability to provide the proper level of review of the design at the proper time in the design cycle of a product. This ability greatly increases the efficiency of both the development and procurement operations collaborating on the design of a product and dramatically decreases development cycle times.

Further, the method allows a designer to communicate the contents of his design (a Bill of Materials) to each of a multitude of Supply Chain Component Engineers (procurement Engineer) responsible for the individual part types within the design such that the individual Supply Chain Component Engineer addresses only those part types for which they are responsible. Additionally, multiple designers are able to simultaneously communicate multiple, unrelated designs to Supply Chain Component Engineers in a fashion such that like part types are aggregated across designs for rapid processing by the Supply Chain Component Engineers responsible for the part type. Also, the recommendations or feedback from multiple Supply Chain Component Engineers, each responsible for different part types within a design's Bill of Material, are recombined back into a format usable to the designer for an individual design.

Non Limiting Hardware and Software Examples

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer system to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method on a central information processing system for creating and maintaining a bill of materials for design and manufacture of a product, the method comprising:
linking, over a network, a plurality of client information processing systems to at least one central processing system;
receiving an assembled bill of materials from an originating party's client information processing system, the bill of materials having been assembled to a predefined point of completion adequate for processing by a reviewing party;
communicating feedback to the reviewing party's client information processing system, automatically, in response to receiving the bill of materials, indicating the bill of materials is ready for processing; and
performing the following at least once, iteratively:
processing the bill of materials by the reviewing party;
communicating feedback to the originating party's client information system, automatically, in response to completing the processing step, indicating the bill of materials has been processed;
editing the bill of materials, by the originating party; and
communicating feedback to the reviewing party's client information system, automatically, in response to completing the editing step, indicating the bill of materials is ready for processing.

2. The method of claim 1, wherein the receiving an assembled bill of materials comprises:
receiving a bill of materials having been assembled by:
validating details of all component parts within the bill of materials;
specifying a chronological stage of design;
sorting each component part into predefined commodity categories; and
entering product details and requirements.

3. The method of claim 2, wherein the chronological stage of the design is one of: concept, logic design, physical design, prototype, and production.

4. The method of claim 1, wherein the processing the bill of materials comprises:
determining a level of collaboration review for each component part of the bill of materials based upon a chronological stage of the design and whether the component part has a pre-existing manufacturing part number.

5. The method of claim 4, wherein the level of collaboration review is one of: no review, recommendation, and new part number request.

6. The method of claim 5, further comprising:
wherein in response to the level of collaboration review to be no review:
incorporating a response indicating no review is necessary into the feedback automatically.

7. The method of claim 5, further comprising:
wherein in response to the level of collaboration review to be recommendation, performing at least one of:
indicating approval of the component part, and
incorporating a response indicating approval of the component part into the feedback automatically; and
indicating disapproval of the component part,
suggesting an alternate component part, and
incorporating a response indicating disapproval of the component part into the feedback automatically.

8. The method of claim 5, further comprising:
wherein in response to the level of collaboration review to be new part number request, performing at least one of:
deferring approval of the component part until additional information is received,
requesting additional information, and
incorporating a response indicating at least one of deference of the component part and the request for additional information into the feedback automatically;
determining not to support the new part number, and
incorporating a response indicating at least one of the determination not to support the component part and comments indicating reasons for not supporting the new part number into the feedback automatically; and
assigning the component part a new part number,
entering at least one of the new part number and information relating to usage of the component part into the bill of materials, and
incorporating a response indicating the new part number for the component part into the feedback automatically.

9. The method of claim 8, further comprising:
creating an engineering change request with relevant data about the new part number automatically.

10. The method of claim 1, wherein the editing the bill of materials comprises performing at least one of the following:
selecting a component part of a bill of materials requiring action,
determining the component part needs to be replaced, and
updating the bill of materials to reflect the replaced part;
selecting a component part of a bill of materials requiring action,
determining a recommended supplier needs approval,
indicating disapproval of the recommended supplier, and
incorporating a response indicating at least one of a supplier disapproval and reasons for not approving the recommended supplier into the feedback automatically; and
selecting a component part of a bill of materials requiring action,
determining a recommended supplier needs approval,
indicating approval of the recommended supplier, and
incorporating a response indicating a supplier approval into the feedback automatically.

11. A computer program product for creating and maintaining a bill of materials for design and manufacture of a product, the computer program product comprising computer instructions for:
linking, over a network, a plurality of client information processing systems to at least one central processing system;
receiving an assembled bill of materials from an originating party's client information processing system, the bill of materials having been assembled to a predefined point of completion adequate for processing by a reviewing party;
communicating feedback to the reviewing party's client information processing system, automatically, in response to receiving the bill of materials, indicating the bill of materials is ready for processing; and
performing the following at least once, iteratively:
processing the bill of materials by the reviewing party;
communicating feedback to the originating party's client information system, automatically, in response to completing the processing step, indicating the bill of materials has been processed;
editing the bill of materials, by the originating party; and
communicating feedback to the reviewing party's client information system, automatically, in response to completing the editing step, indicating the bill of materials is ready for processing.

12. The computer program product of claim 11, wherein the receiving an assembled bill of materials comprises:
receiving a bill of materials having been assembled by:
validating details of all component parts within the bill of materials;
specifying a chronological stage of design;
sorting each component part into predefined commodity categories; and
entering product details and requirements.

13. The computer program product of claim 11, wherein the processing the bill of materials comprises:
determining a level of collaboration review for each component part of the bill of materials based upon a chronological stage of the design and whether the component part has a pre-existing manufacturing part number.

14. The computer program product of claim 13, wherein the level of collaboration review is one of: no review, recommendation, and new part number request.

15. The computer program product of claim 11, wherein the editing the bill of materials comprises performing at least one of the following:
selecting a component part of a bill of materials requiring action,
determining the component part needs to be replaced, and
updating the bill of materials to reflect the replaced part;
selecting a component part of a bill of materials requiring action,
determining a recommended supplier needs approval,
indicating disapproval of the recommended supplier, and
incorporating a response indicating at least one of a supplier disapproval and reasons for not approving the recommended supplier into the feedback automatically; and
selecting a component part of a bill of materials requiring action,
determining a recommended supplier needs approval,
indicating approval of the recommended supplier, and
incorporating a response indicating a supplier approval into the feedback automatically.

16. A central information processing system for creating and maintaining a bill of materials for design and manufacture of a product, the computer system comprising:
means for linking, over a network, a plurality of client information processing systems to at least one central processing system;
means for receiving an assembled bill of materials from an originating party's client information processing system, the bill of materials having been assembled to a predefined point of completion adequate for processing by a reviewing party;
means for communicating feedback to the reviewing party's client information processing system, automatically, in response to receiving the bill of materials, indicating the bill of materials is ready for processing; and
means for performing the following at least once, iteratively:
processing the bill of materials by the reviewing party;
communicating feedback to the originating party's client information system, automatically, in response to completing the processing step, indicating the bill of materials has been processed;
editing the bill of materials, by the originating party; and
communicating feedback to the reviewing party's client information system, automatically, in response to completing the editing step, indicating the bill of materials is ready for processing.

17. The central information processing system of claim 16, wherein the receiving an assembled bill of materials comprises:
means for receiving a bill of materials having been assembled by:
validating details of all component parts within the bill of materials;
specifying a chronological stage of design;
sorting each component part into predefined commodity categories; and
entering product details and requirements.

18. The central information processing system of claim 16, wherein the processing the bill of materials comprises:
means for determining a level of collaboration review for each component part of the bill of materials based upon a chronological stage of the design and whether the component part has a pre-existing manufacturing part number.

19. The central information processing system of claim 18, wherein the level of collaboration review is one of: no review, recommendation, and new part number request.

20. The central information processing system of claim 16, wherein the editing the bill of materials comprises means for performing at least one of the following:
selecting a component part of a bill of materials requiring action,
determining the component part needs to be replaced, and
updating the bill of materials to reflect the replaced part;
selecting a component part of a bill of materials requiring action,
determining a recommended supplier needs approval,
indicating disapproval of the recommended supplier, and
incorporating a response indicating at least one of a supplier disapproval and reasons for not approving the recommended supplier into the feedback automatically; and
selecting a component part of a bill of materials requiring action,
determining a recommended supplier needs approval,
indicating approval of the recommended supplier, and
incorporating a response indicating a supplier approval into the feedback automatically.
